(19) United States
(12) Patent Application Publication
(10) Pub. No.: US 2026/0225953 A1
(43) Pub. Date: Aug. 6, 2026

(54) KILN AND METHOD FOR BURNING CARBONATE ROCK

(71) Applicants: Maerz Ofenbau AG, Zurich (CH); thyssenkrupp Polysius GmbH, Beckum (DE); thyssenkrupp AG, Essen (DE)

(72) Inventors: Hannes PIRINGER, Beinwil am See (CH); Patrick BUCHER, Schoenenwerd (CH)

(73) Assignees: Maerz Ofenbau AG, Zurich (CH); thyssenkrupp Polysius GmbH, Beckum (DE); thyssenkrupp AG, Essen (DE)

(21) Appl. No.: 19/152,791

(22) PCT Filed: Jan. 30, 2024
(86) PCT No.: PCT/EP2024/052224

§ 371 Date: Jul. 31, 2025

(30) Foreign Application Priority Data
Feb. 1, 2023 (BE) BE 2023/5063
Feb. 1, 2023 (DE) 10 2023 102 446.9

(51) Int. Cl. C04B 2/12; F27B 1/04; F27B 1/22; F27B 1/24; F27B 1/26; F27D 13/00; F27D 17/13

(52) U.S. Cl. CPC C04B 2/12; F27B 1/04; F27B 1/22; F27B 1/24; F27B 1/26; F27D 13/00; F27D 17/13; F27M 2003/03

(57) ABSTRACT

A method of burning material, such as carbonate rock, in a parallel-flow regenerative shaft kiln having two shafts which are operated alternately as burning shaft and as regenerative shaft and are connected to one another by a connecting duct, wherein the material flows to a material outlet through a material inlet into a preheating zone for preheating of the material, a burning zone for burning the material and a cooling zone for cooling the material, wherein a cooling gas is admitted into the cooling zone, wherein offgas is discharged from one shaft of the kiln via an offgas outlet disposed within or above the preheating zone and wherein the offgas discharged from the shaft via the offgas outlet is branched into a first portion of the offgas and a second portion of the offgas, and wherein the first portion of the offgas is fed via a first offgas inlet to an upper region of the preheating zone, wherein the second portion of the offgas discharged from the shaft is fed to the preheating zone via a second offgas inlet downstream of the first offgas inlet.

The invention relates to a kiln and to a method of burning and cooling material, such as carbonate rock, with a PFR shaft kiln. The kiln is, for example, a parallel-flow regenerative shaft kiln (PFR shaft kiln) or a shaft kiln, in particular an annular shaft kiln.

The burning of carbonate rock in a shaft kiln or a PFR shaft kiln has been known for about 60 years. A PFR shaft kiln of this kind, which is known for example from WO 2011/072894 A1, has two vertical, parallel shafts in cyclical operation, with burning only in one shaft, the respective burning shaft, while the other shaft works as a regenerative shaft. The burning shaft is supplied with oxidation gas in cocurrent with the material and fuel, and the resultant hot offgases, together with the heated cooling air which is supplied from below, are conducted via the crossover duct into the offgas shaft, where the offgases are conducted away upward in countercurrent to the material and at the same time preheat the material. The material is typically fed into the shaft from above together with the oxidation gas, with injection of fuels in the burning zone.

In each shaft, the material to be burned typically passes through a preheating zone for preheating of the material, a downstream burning zone in which the material is burned, and a downstream cooling zone in which cooling air is supplied to the hot material.

In order to meet quality demands with respect to high reactivity of the burnt lime, as required for example in steelworks, the temperatures in the burning zone must not exceed a value of 1100° C., preferably 1000° C. Furthermore, demand for environmentally friendly production of burnt lime is also increasing, and so certain requirements for the CO₂ content of the offgas for subsequent aftertreatment must be met. A known way of increasing the CO₂ content in the offgas is to return at least a portion of the offgas to one of the shafts. Such offgas recirculation requires an elaborate and costly treatment of the offgas before it can be returned to the shaft.

From this starting point, it is an object of the present invention to provide a kiln, such as a shaft kiln and/or an inexpensive and energy-efficient PFR shaft kiln, and a method of burning carbonate rock with such a kiln, with which lime is produced with high reactivity, with simultaneous enablement of separation of CO₂ from the offgas.

This object is achieved according to the invention by an apparatus having the features of independent method claim 1 and by a method having the features of independent apparatus claim 10. Advantageous refinements are derived from the dependent claims.

In a first aspect, the invention encompasses a method of burning material, such as carbonate rock, in a parallel-flow regenerative shaft kiln having two shafts which are operated alternately as burning shaft and as regenerative shaft and are connected to one another by means of a connecting duct, wherein the material flows to a material outlet through a material inlet into a preheating zone for preheating of the material, a burning zone for burning the material and a cooling zone for cooling the material, wherein a cooling gas is admitted into the cooling zone, wherein offgas is discharged from one shaft of the kiln via an offgas outlet disposed within or above the preheating zone and wherein the offgas discharged from the shaft via the offgas outlet is branched into a first portion of the offgas and a second portion of the offgas, and wherein the first portion of the offgas is fed via a first offgas inlet to an upper region of the preheating zone. The second portion of the offgas discharged from the shaft is fed to the preheating zone via a second offgas inlet downstream of the first offgas inlet.

Feeding of offgas at two different positions within the preheating zone ensures an optimal offgas flow within the preheating zone, with reliable prevention in particular of too low a temperature within the preheating zone and hence avoidance of condensation of the offgas within the preheating zone. This additionally reduces the risk of corrosion in the components involved in further offgas treatment. The shaft preferably has a plurality of first offgas inlets that are arranged, for example, circumferentially around the shaft, in particular at the same height, and which are supplied with the first portion of the offgas. The first offgas inlets are preferably each connected to a conduit, in particular an annular conduit, for conduction of the first portion of the offgas. For example, the first offgas inlets are in a uniformly spaced-apart arrangement. The shaft preferably has a plurality of second offgas inlets that are arranged, for example, circumferentially around the shaft, in particular at the same height, and which are supplied with the second portion of the offgas. The second offgas inlets are preferably each connected to a conduit, in particular an annular conduit, for conduction of the second portion of the offgas. For example, the second offgas inlets are in a uniformly spaced-apart arrangement.

The offgas discharged from the shaft via the offgas outlet is, for example, completely cooled in a cooling device and then heated in a heating device to a temperature of not more than 200° C., in particular 50° C. to 160° C., preferably 70° C. to 120° C. This brings about a reduction in the relative moisture content of the offgas. In particular, the risk of water condensing out and causing operational problems in the compressors is greatly reduced. It is also possible that only a portion of the offgas is fed to the cooling device and then to the heating device. For example, the offgas is cooled in the cooling device to a temperature of 10° C. to 50° C., in particular 15° C. to 40° C. This at least partly condenses the water in the offgas, which reduces the absolute moisture content of the offgas. The cooling device and/or the heating device are optionally designed as a heat exchanger. This allows utilization of the waste heat, in particular the temperature differential of a fluid at another position in the kiln process. For example, the offgas is dedusted in a filter prior to cooling in the cooling device. The filter is preferably disposed between the offgas outlet and the cooling device. The filter is preferably a dust filter for filtering dust particles out of the offgas. For example, the filter is operated under positive pressure or under negative pressure with a fan installed downstream. Preferably, a compressor, in particular a fan, is disposed upstream of the filter in flow direction of the offgas.

The material to be burned is preferably limestone or dolomite rock having a grain size of 10 to 200 mm, preferably of 15 to 120 mm, most preferably 30 to 100 mm. The cooling gas is air, for example. The fuel supplied to the kiln is preferably methane or hydrogen. At the offgas outlet, the offgas preferably has a water content of about 5% by volume to 40% by volume, in particular 10% by volume to 25% by volume, while the temperature is, for example, about 80° C. to 100° C. and, especially on startup of the system, less than 80° C.

For example, the kiln is a parallel-flow regenerative shaft kiln with two parallel shafts or a shaft kiln with exactly one shaft. A parallel-flow regenerative shaft kiln has at least two shafts that are preferably in a vertical arrangement parallel to one another. The shafts are operable alternately as burning shaft and as regenerative shaft, where each shaft has, in flow direction of the material, a preheating zone for preheating the material, a burning zone for burning the material and a cooling zone for cooling the material. Each shaft preferably has a material inlet for admitting material to be burned into the shaft, where the material inlet is in particular at the upper end of the respective shaft, such that the material falls into the respective shaft under gravity. The material inlet and/or the material outlet is/are in particular in the form of a lock for admitting and/or discharging material into the shaft kiln. A material inlet in the form of a lock is preferably designed such that only the raw material to be burned gets into the shaft, but not the ambient air. The material lock also prevents gas from escaping from the shaft via the material inlet. The lock is preferably designed to seal the shaft airtight against the environment and to allow solids, such as the material to be burned, to enter the shaft.

The connecting duct is designed for gaseous connection of the two shafts and preferably connects the burning zones of the shafts to one another. In the course of operation of the PFR shaft kiln, one of the shafts at a time is operated as a burning shaft and is active, while the respective other shaft is operated as a regenerative shaft and is passive. The PFR shaft kiln is in particular operated in cycles, with switching of the function of the shafts after the cycle time has elapsed. This procedure is repeated continuously. In the active shaft operated as burning shaft, a fuel is introduced into the burning zone via the burner lances. The material to be burned is heated in the preheating zone of the burning shaft, preferably to a temperature of about 700° C. In the shaft operated as burning shaft, the burning zone is in the form of a cocurrent burning zone, where the material to be burned flows parallel to the gas. The gas flows wherein the burning shaft from the preheating zone into the burning zone and then via the connecting duct into the burning zone and the preheating zone of the regenerative shaft. In the shaft operated as regenerative shaft, the gas flow in the preheating zone and the burning zone is in countercurrent to the material to be burned.

Both in the burning shaft and in the regenerative shaft, cooling gas is conducted through the cooling zone in countercurrent to the material to be cooled and is preferably discharged completely from the shaft via the cooling gas outlet of the cooling air removal device, such that there is preferably no flow of cooling gas from the cooling zone into the burning zone.

Each shaft preferably has at least one offgas outlet, for example at the upper end of the shaft within the preheating zone. The offgas outlet is preferably disposed above the material column in a material-free region of the preheating zone. The offgas is preferably discharged exclusively from one shaft, in particular the regenerative shaft.

The discharged offgas is preferably fed to the respective other shaft, in particular the burning shaft, or to the regenerative shaft. Preferably, only a portion of the offgas discharged from the regenerative shaft is fed back to at least one shaft. A portion of the offgas discharged from the regenerative shaft is, for example, discharged from the PFR shaft kiln and fed, for example, to a further treatment, such as a sequestration. The offgas preferably consists of CO₂ and optionally H₂O.

A fuel is preferably fed to the burning zone and/or the preheating zone of the shaft operated as a burning shaft via a fuel conduit. The fuel is preferably fed to burner lances disposed in the burning zone and/or the preheating zone. The fuel is for example a fuel gas, such as blast furnace gas, methane, hydrogen or natural gas, or coal dust or biomass or liquid fuels. The material is preferably heated to a temperature of about 1100° C. in the burning zone.

Each shaft preferably has a multiplicity of burner lances which extend at least partly through the preheating zone and in particular open into the burning zone of the respective shaft and serve to conduct, for example, fuel and/or an oxidizing gas, such as air or oxygen-enriched air or pure oxygen. Preferably, the fuel gas outlet of the burner lances is disposed at the upper end of the burning zone, such that the preheating zone extends up to the fuel gas outlet of at least one burner lance.

Returning the offgas to at least one shaft or both shafts enables the production of lime with a high reactivity, with simultaneous production of process gas having a CO₂ content of more than 90% based on dry gas. Such a process offgas enables liquefaction and sequestration thereof with a relatively low level of complexity. For example, the liquefied process offgas is fed to further process steps or stored. Alternatively, the above-described PFR shaft kiln can be used to produce offgas having a low CO₂ content, for example 45% for soda production or 35% for sugar production or 30% for the production of precipitated calcium carbonate.

In particular, the offgas is introduced into the preheating zone of the shaft operated as burning shaft and/or as regenerative shaft. Each shaft preferably has an offgas inlet, in particular a combustion gas inlet, which is disposed in the upper region of the shaft in the preheating zone and serves to admit the gas required for combustion.

The PFR shaft kiln preferably has a branch downstream of the offgas outlet, which is designed and set up in such a way that it branches off the offgas discharged from the offgas outlet into a first portion of the offgas and a second portion of the offgas. Preferably, the branch, in flow direction of the offgas, is disposed beyond a dust filter, the heating device and/or the cooling device. The first portion of the offgas is supplied via a first offgas inlet to an upper region of the preheating zone of the burning shaft and/or the regenerative shaft, while the second portion of the offgas is supplied via a second offgas inlet downstream of the first offgas inlet to the preheating zone of the burning shaft and/or the regenerative shaft. Preferably, the preheating zone of the burning shaft and the regenerative shaft each have a first offgas inlet, and a second offgas inlet disposed beyond the latter in flow direction of the material.

In particular, the amount of offgas which is supplied to the preheating zone of the shaft operated as a burning shaft and/or the shaft operated as a regenerative shaft via the first and/or the second offgas inlet is adjustable. The PFR shaft kiln preferably has at least one control element, such as a flap or a valve. There is preferably a control element upstream of each of the first and second offgas inlet, such that the amount of the first portion of the offgas to the first offgas inlet and/or the amount of the second portion of the offgas to the second offgas inlet is adjustable. In particular, the amount of offgas to the first and/or the second offgas inlet is adjusted depending on the CO₂ content of the offgas.

In a first embodiment, the oxygen is fed into the first and/or the second portion of the offgas prior to introduction into the preheating zone. Preferably, an offgas conduit connected to the offgas outlet is connected to an oxidant conduit for conduction of oxygen, such that oxygen is introduced into the offgas conduit. For example, air, an oxygen-rich gas or pure oxygen is supplied to the first and/or second portion of the offgas. The oxidant conduit is preferably connected to an oxygen source. For example, the PFR shaft kiln has at least two oxidant conduits, each connected to an offgas inlet for admission of offgas into the preheating zone. In particular, oxygen is supplied to the first offgas inlet and/or exclusively to the second offgas inlet of the preheating zone of the shaft operated as burning shaft.

In a further embodiment, the second portion of the offgas is compressed to about 100 mbar to 600 mbar, preferably 200 mbar to 550 mbar, in particular 500 mbar, prior to introduction into the preheating zone of the burning shaft. The PFR shaft kiln preferably has a compressor which is disposed between the offgas outlet and the second offgas inlet and is designed to compress the second portion of the offgas to about 100 mbar to 600 mbar, preferably 200 mbar to 550 mbar, in particular 500 mbar. This counteracts any pressure drop within the PFR shaft kiln. Preferably, the second portion of the offgas, prior to introduction into the preheating zone of the regenerative shaft, is compressed to about 50 mbar to 300 mbar, preferably 70 mbar to 200 mbar, in particular 150 mbar. When the second portion of the offgas is introduced into the second offgas inlet in the regenerative shaft, the pressure drop within the PFR kiln is preferably lower than on introduction into the burning shaft.

In a further embodiment, the second portion of the offgas is introduced into the preheating zone at the lower end thereof, in particular directly. In particular, the second portion of the offgas is introduced into the preheating zone upstream of the burning zone in flow direction of the material, in particular upstream of a combustion gas outlet of a burner lance. The second portion of the offgas is preferably introduced into the preheating zone via one or more offgas inlets formed as a passage in the shaft wall above the burning zone.

In a further embodiment, the second portion of the offgas is heated to a temperature of 500° C. to 800° C., in particular 550° C. to 700° C., preferably 600° C., prior to introduction into the second offgas inlet. Preferably, the second portion of the offgas is heated at least in part or in full in a heat exchanger. This ensures optimum preheating of the material within the preheating zone.

In a further embodiment, the second portion of the offgas is introduced into a region of the preheating zone which is at a temperature corresponding to the temperature of the second portion of the offgas and/or a temperature of 500° C. to 800° C., in particular 550° C. to 700° C., preferably 600° C. Preferably, the preheating zone is at a gas temperature of 70° C. to 800° C., where the gas is at a temperature of about 70° C. to 100° C. at the upper end of the preheating zone and the gas is at a temperature of about 700° C. to 900° C., preferably 800° C., at the lower end. The gas temperature preferably rises continuously in flow direction of the material. The second offgas inlet is preferably disposed at a height of the preheating zone at which a gas temperature of 500° C. to 800° C., in particular 550° C. to 700° C., preferably 600° C., is established within the preheating zone.

In a further embodiment, the preheating zone has a length extending in flow direction of the material, wherein the second offgas inlet for admission of offgas into the preheating zone is at a distance from the upper end of the burning zone in flow direction of the material and wherein the ratio of the distance to the length is 0 to 0.5, in particular 0.2 to 0.3, preferably 0.25. The preheating zone preferably extends from the fill height of the material and/or from the material inlet up to the burning zone, in particular up to a fuel gas outlet of a burner lance. Such a ratio gives optimal mixing of the gas streams within the preheating zone with an optimal capacity flow ratio.

In a further embodiment, the cooling gas heated in the cooling zone is discharged from the cooling zone of the shaft via a cooling gas removal device and fed to a heat exchanger for heating of the second portion of the offgas, in particular in countercurrent.

The cooling gas heated in the cooling zone is preferably discharged from the cooling zone of the shaft via the cooling gas removal device. In particular, the cooling gas admitted into the cooling zone is fully discharged from the respective shaft via the cooling gas removal device.

The cooling gas removal device preferably has a material-free space within the cooling zone of the shaft. The material-free space in the cooling gas removal device takes the form, for example, of an inner cylinder which, in particular, extends through the cooling zone centrally and in the vertical direction. In particular, the inner cylinder extends at least partly into the burning zone or ends at a vertical distance from the burning zone.

The cooling gas outlet for discharging the cooling gas from the shaft is disposed within the inner cylinder. The inner cylinder preferably has a cooling gas inlet for admitting cooling gas from the cooling zones into the interior of the inner cylinder, while the cooling gas inlet is preferably disposed above the cooling gas outlet in the inner cylinder. In particular, the cooling gas inlet is disposed at the upper end of the cooling zone, such that the cooling gas preferably flows through the entire cooling gas zone and then into the inner cylinder of the cooling gas removal device. Within the inner cylinder, the cooling gas preferably flows downward in the direction of the cooling gas outlet and into the cooling gas removal conduit. The cooling gas removal device is preferably designed such that it discharges all the cooling gas from the shaft, such that preferably no cooling gas gets into the burning zone or the connecting duct for connecting the burning zones of the shafts. In particular, the cooling gas removal device is connected to a control element, such as a flap or a valve, in order to adjust the amount of cooling gas to be removed.

The invention also encompasses a parallel-flow regenerative shaft kiln for burning and cooling material, such as carbonate rock, having two shafts that are operable alternately as burning shaft and as regenerative shaft and are connected to one another by means of a connecting duct, where each shaft has, in flow direction of the material, a preheating zone for preheating the material, a burning zone for burning the material and a cooling zone for cooling the material, where at least one shaft of the PFR shaft kiln has an offgas outlet disposed within or above the preheating zone for discharging offgas from the shaft and a first offgas inlet for admission of offgas, and where the offgas outlet is connected to the first offgas inlet for admission of a first portion of the offgas into the preheating zone. The shaft has, within the preheating zone, a second offgas inlet which is beyond the first offgas inlet in flow direction of the material and which is connected to the offgas outlet for admission of a second portion of the offgas into the preheating zone.

The embodiments and advantages described with reference to the method of burning material, such as carbonate rock, in a PFR shaft kiln are likewise correspondingly applicable to the PFR shaft kiln with regard to the apparatus.

In one embodiment, the shaft kiln has a control element upstream of the first and/or the second offgas inlet for controlling the amount of offgas which is fed via the first and/or second offgas inlet to the preheating zone of the shaft operated as burning shaft and/or of the shaft operated as regenerative shaft.

In a further embodiment, the shaft kiln has at least one oxidant conduit which is connected to the first and/or the second offgas inlet for introduction of an oxidant into the offgas. The oxidant is, for example, air, an oxygen-rich gas or pure oxygen.

In a further embodiment, a compressor connected upstream of the second offgas inlet is designed and set up such that it compresses the offgas, prior to introduction into the second offgas inlet of the burning shaft, to a pressure of 100 mbar to 600 mbar, preferably 200 mbar to 550 mbar, in particular 500 mbar. In particular, a compressor connected upstream of the second offgas inlet is designed and set up such that it compresses the offgas, prior to introduction into the second offgas inlet of the regenerative shaft, to a pressure of 50 mbar to 300 mbar, preferably 70 mbar to 200 mbar, in particular 150 mbar.

In a further embodiment, the second offgas inlet is disposed at the lower end of the preheating zone.

In a further embodiment, a heat exchanger disposed between the offgas outlet and the second offgas inlet is designed and set up so as to heat the second portion of the offgas to a temperature of 500° C. to 800° C., in particular 550° C. to 700° C., preferably 600° C.

In a further embodiment, the preheating zone has a length A extending in flow direction of the material, where the second offgas inlet for admission of offgas into the preheating zone is at a distance B from the upper end of the burning zone 20 in flow direction of the material and where the ratio B/A of the distance B to the length A is 0 to 0.5, in particular 0.2 to 0.3, preferably 0.25.

In a further embodiment, the cooling zone has a cooling gas inlet for admission of cooling gas into the cooling zone and a cooling gas removal device for discharge of cooling gas from the shaft, and where the cooling gas removal device is connected to the heat exchanger for heating of the second portion of the offgas, especially in countercurrent.

### DESCRIPTION OF THE DRAWINGS

The invention is elucidated in detail hereinafter by a number of working examples with reference to the appended figures.

FIG. 1 shows a schematic diagram of a PFR shaft kiln in a section view in one working example.

FIG. 2 shows a schematic diagram of a detail of a PFR shaft kiln in the embodiment of FIG. 1 in a section view.

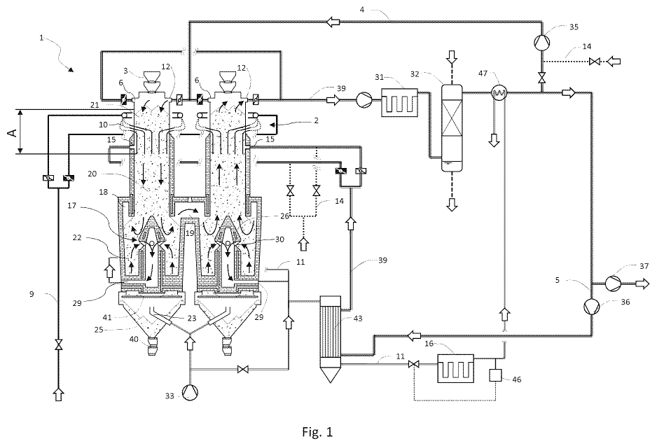

FIG. 1 shows a kiln, more particularly a PFR shaft kiln 1, having two parallel and vertically oriented shafts 2. The shafts 2 of the PFR shaft kiln 1 are of essentially identical construction, and so only one of the two shafts 2 is given reference signs in FIG. 1 and only one of the two shafts 2 is described below for the sake of simplicity. Each shaft 2 has a respective material inlet 3 for admitting material to be burned into the respective shaft 2 of the PFR shaft kiln 1. The material to be burned is in particular limestone and/or dolomite rock, preferably having a grain size of 10 to 200 mm, preferably of 15 to 120 mm, most preferably 30 to 100 mm. By way of example, the material inlets 3 are disposed at the upper end of the respective shaft 2, such that the material falls through the material inlet 3 into the shaft 2 under gravity. The material inlet 3 takes the form, for example, of an upper opening in the shaft 2 and in particular that of a lock 3, and preferably extends over the entirety or a portion of the cross section of the shaft 2. A material inlet in the form of a lock 3 is preferably configured such that only the raw material to be burned gets into the shaft 2, but not the ambient air. The lock 3 is preferably configured such that it seals off the shaft 2 against the environment in an airtight manner and allows solids, such as the material to be burned, to enter the shaft.

Each shaft 2 additionally has, at its upper end, a combustion gas inlet 12 for admitting combustion gas for combustion of fuels. The combustion gas inlet 12 is a first offgas inlet 12, where each shaft 2 preferably has a second offgas inlet 15 disposed beyond the first offgas inlet 12 in flow direction of the material. For example, the shaft 2 has a multitude of first and second offgas inlets that are in particular at the same height in terms of circumference and/or equally spaced apart from one another. The combustion gas is, for example, dedusted offgas from at least one of the shafts 2, with the offgas preferably being enriched with oxygen. Furthermore, each shaft 2 has an offgas outlet 6 for discharging offgases from the respective shaft 2. By way of example, each offgas outlet 6 and offgas inlet 12, 15 is assigned a control element. The control elements, for example a compressor 35 of controllable volume, can preferably be used to adjust the amount of combustion gas, especially offgas, in the respective offgas inlet 12, 15 and the amount of offgas to be removed via the respective offgas outlet 6. The first offgas inlet 12 and the offgas outlet 6 are disposed by way of example at the same height level and in particular within the preheating zone 21 of the respective shaft 2. By way of example, the first offgas inlet 12 and the offgas outlet 6 are disposed in an upper end region, in particular the material-free upper end of the preheating zone 21 of the respective shaft 2.

Disposed at the lower end of the shaft 2 is a material outlet 40 for discharging the burnt material. The material outlet 40 is, for example, a lock as described with reference to the material inlet 3.

The burned material is conducted, for example, into an outlet funnel 25 adjoined by the material outlet 40 of the shaft 2. By way of example, the outlet funnel 25 is funnel-shaped. The outlet funnel 25 preferably has a cooling gas inlet 23 for admitting cooling gas into the respective shaft 2. The cooling gas is preferably conducted into the cooling gas inlet by means of a compressor 33.

In operation of the PFR shaft kiln 1, the material to be burned flows from the top downward through the respective shaft 2, while the cooling air flows from the bottom upward, in countercurrent to the material, through the respective shaft 2. The kiln offgas is discharged from the shaft 2 through the offgas outlet 6.

The bottom end of the material inlet 3 and of the first offgas inlet 12 is adjoined in flow direction of the material by the preheating zone 21 of the respective shaft 2. The material and the combustion gas are preferably preheated to about 700° C. in the preheating zone 21. The respective shaft 2 is preferably filled with material to be burned. The material is preferably fed into the respective shaft 2 above the preheating zone 21. At least A portion of the preheating zone 21 and that portion of the respective shaft 2 which adjoins it in flow direction of the material are surrounded, for example, by a refractory lining.

A multitude of burner lances 10 that each open into the burning zone 20 are optionally disposed in the preheating zone 21 and each serve as an inlet for fuel, for example a fuel gas, oil or ground solid fuel. The PFR shaft kiln 1 has, for example, a cooling device for cooling the burner lances 10. The cooling device comprises, for example, a multitude of annular cooling air conduits which extend annularly around the shaft region in which the burner lances 10 are disposed. Cooling air for cooling of the burner lances 10 preferably flows through the annular cooling air conduits. Preferably, the burner lances 10 are cooled by means of the offgas discharged via the offgas outlet 6. The offgas outlet 6 is preferably connected to the burner lances 10 for conduction of offgas to the burner lances 10.

The burner lances 10 are preferably connected to a fuel conduit 9 for conduction of fuel to the burner lances 10. By way of example, the fuel conduit 9 is at least partly in the form of an annular conduit that extends circumferentially around the respective shaft 2. Preferably, each shaft 2 has a fuel conduit which is assigned in each case to the burner lances 10 of the shaft 2 and which in particular has a respective control element for adjusting the amount of fuel to the burner lances 10.

The preheating zone 21 is adjoined in flow direction of the material by the burning zone 20. In the burning zone 20, the fuel is combusted and the preheated material is burned at a temperature of about 1000° C. Preferably, the burner lances each have fuel outlets at their ends, where the burning zone 20 in particular extends from the fuel outlets of the burner lances 10 in flow direction of the material. The PFR shaft kiln 1 also has a connecting duct 19 for gaseous connection of the two shafts 2 to one another. There is in particular no material to be burned in the connecting duct 19.

By way of example, FIG. 1 shows a PFR lime kiln 1 with round shaft cross sections. However, the shaft cross section may have a different geometric outline, for example round, semicircular, oval, square or polygonal.

The burning zone 20 is adjoined in flow direction of the material in each shaft 2 by a cooling zone 22 which extends as far as the discharge device 41. The material is cooled within the cooling zone 22 to about 100° C. in countercurrent to the cooling gas flowing through the material.

Each cooling zone 22 has a respective cooling air removal device 17 having a respective cooling gas outlet 29. The cooling gas flowing into the cooling zone 22 via the cooling gas inlet 23 preferably flows completely out of the respective shaft 2 via the cooling gas outlet 29 of the cooling air removal device 17.

Each cooling zone 22 has a cooling gas removal device 17 which comprises an inner cylinder 26 which extends from the cooling zone 22 at least partly into the burning zone 20 or up to a level spaced apart from the burning zone and has a cooling gas outlet 29 connected to the cooling gas removal conduit 11.

The cooling zone 22 is formed by way of example in a shaft section which has an approximately constant cross section, where the shaft cross section of the cooling zone 22 corresponds roughly to the shaft cross section of the lower region of the burning zone 20. For example, a material-free annular space is formed at the level of the connecting duct 19. Each shaft 2 of the PFR shaft kiln 1 preferably has an inner cylinder 26 which extends centrally in vertical direction through the cooling zone 22. By way of example, the inner cylinder 26 extends from the discharge device 41 through the cooling zone 22 into the burning zone 20 as far as the level of the connecting duct 19. The inner cylinder 29 is cooled by a multitude of cooling air channels formed in its outer walls, which are connected to a cooling air conduit (not shown) for conducting cooling air. By way of example, the heated cooling air is conducted into the cooling gas removal conduit 11 and preferably conducted into the heat exchanger 43 to heat the offgas. For example, the heated cooling air is used as energy source for other processes, for example drying of biomass or limestone.

The inner cylinder 26 of the cooling gas removal device 17 has a cooling gas outlet 29 which extends radially outward from the inner cylinder 26 through the shaft wall and serves to conduct cooling gas from the inner cylinder 26 into the cooling gas removal conduit 11. The inner cylinder 26 additionally has a cooling gas inlet 30 for admitting cooling gas from the cooling zone 22 into the inner cylinder 26. The cooling gas inlet 30 extends through the inner cylinder wall into the cooling zone 22 and connects the interior of the inner cylinder 26 to the cooling zone 22. The cooling gas inlet 30 is preferably disposed above the cooling gas outlet 29 in the cooling zone 22. In operation of the PFR shaft kiln 1, the cooling gas flows from the bottom upward through the cooling zone 22 and into the cooling gas inlet 30 into the inner cylinder 26 of the cooling gas removal device 17. Preferably, all the cooling gas introduced into the cooling zone 22 flows through the cooling gas inlets 30 into the cooling gas removal device 17, and so no cooling gas gets into the burning zone 20. The cooling air outlet 29 of the inner cylinder 26 is preferably disposed in the lower region of the cooling zone 22. In particular, the cooling gas flows downward from the cooling gas inlet 30 in the inner cylinder 26 to the cooling gas outlet 29.

A discharge device 41 is preferably disposed at the material outlet end of each shaft 2. The discharge devices 41 include, for example, horizontal plates, preferably a discharge table, which allow the material to pass through laterally between the discharge table and the housing wall of the PFR shaft kiln. The discharge device 41 is preferably designed as a slide table or turntable or as a table with pushable scrapers. This enables a uniform throughput rate of the material to be burned through the shafts 2. By way of example, the discharge device 41 further comprises the outlet funnel 25, which adjoins the discharge table and has the material outlet 40 mounted at its lower end.

In operation of the PFR shaft kiln 1, one of the shafts 2 is active at any time, with the respectively other shaft 2 being passive. The active shaft 2 is referred to as burning shaft and the passive shaft 2 as regenerative shaft. The PFR shaft kiln 1 is in particular operated cyclically, with a typical number of cycles being 75 to 150 cycles per day, for example. After the cycle time has elapsed, the function of the shafts 2 is switched. This procedure is repeated continuously. Material such as limestone or dolomite rock is alternately fed into the shafts 2 via the material inlets 3. In the active shaft 2 operated as burning shaft, a fuel is introduced into the burning shaft 2 via the burner lances 10. The material to be burned is heated to a temperature of about 700° C. in the preheating zone 21 of the burning shaft. In the working example of FIG. 1, the left-hand shaft 2 is operated as burning shaft, while the right-hand shaft 2 is operated as regenerative shaft.

In operation of the PFR shaft kiln 1, both in the burning shaft 2 and in the regenerative shaft 2, the cooling gas flows through the cooling zone 22 in countercurrent to the material to be cooled and is preferably completely discharged from the shaft 2 via the cooling gas outlet 29, such that preferably no cooling gas flows from the cooling zone 22 into the burning zone 20.

Within the shaft 2 operated as a burning shaft, the combustion gas flows through the first offgas inlet 12 into the burning shaft and in cocurrent with the material inside the burning zone 20 into the material-free space in the form of an annular duct 18. The gas flows from the material-free space 18 via the connecting duct 19 into the shaft 2 operated as regenerative shaft. Within the regenerative shaft, the gas flows from the connecting duct 19 and the material-free space 18 of the regenerative shaft in countercurrent to the material to be burned through the burning zone 20 into the preheating zone 21, and leaves the regenerative shaft through the offgas outlet 6 of the regenerative shaft. The offgas discharged from the shaft 2 is preferably at a temperature of 60° C. to 160° C., preferably 100° C.

The offgas is conducted into an offgas conduit 39 which adjoins the offgas outlet 6. The offgas conduit 39 optionally has, downstream of the offgas outlet 6 in flow direction of the offgas, an offgas filter 31 for filtering fine particles, in particular dust, out of the offgas. Downstream of the offgas filter 31, the offgas conduit 39 has a branch, where a first portion of the offgas is conducted in a combustion gas conduit 4 to the first offgas inlet 12. Downstream of the branch, the combustion gas conduit 4 has, in flow direction of the first portion of the offgas, by way of example, a control element, for example a butterfly valve, and a compressor 35. The combustion gas conduit 4 is preferably connected to the first offgas inlet 12 of the shafts 2, with the offgas being fed preferably solely to the first offgas inlet 12 of the shaft 2 operated as burning shaft via a control element connected upstream of the first offgas inlet 12. It is likewise conceivable that the offgas from the combustion gas conduit 4 is fed exclusively to the regenerative shaft or to both shafts 2. The combustion gas conduit 4 is preferably connected to an oxidant conduit 14 such that an oxidant, preferably pure oxygen, is introduced into the combustion gas conduit 4 and then into the shaft 2 via the first offgas inlet 12 together with the offgas. It is likewise conceivable that the oxidant introduced into the combustion gas conduit 4 is an oxygen-rich gas having a proportion of oxygen of at least 70% to 95%, preferably 90%.

The portion of the offgas which is not returned to the first offgas inlet 12 is referred to as the second portion of the offgas and is fed in the offgas conduit 39 to a second offgas inlet 15 in the preheating zone 21. Downstream of the branch of the combustion gas conduit 4 in flow direction of the second portion of the offgas, the offgas conduit 39 preferably has a compressor 36 of controllable volume and a heat exchanger 43. By way of example, the heat exchanger 43 is in the form of a recuperator, where the second portion of the offgas is heated in countercurrent to the cooling gas removed and the cooling gas is cooled simultaneously. In particular, the heat exchanger 43 is connected to the cooling gas outlets 29 of the two shafts 2 via a cooling gas removal conduit 11, such that the second portion of the offgas is heated in the heat exchanger 43, preferably in countercurrent, by means of the cooling gas removed. Downstream of the heat exchanger 43, the cooling gas removal conduit 11 optionally has a control element for adjusting the amount of cooling gas to be removed and a filter 16 for dedusting the cooling gas. The second portion of the offgas is preferably heated in the heat exchanger 43 to a temperature of about 500° C. to 800° C., in particular 550° C. to 700° C., preferably 600° C.

Downstream of the heat exchanger 43 and upstream of the second offgas inlet 15, the offgas conduit 39 is preferably connected to an oxidant conduit 14 for introduction of an oxidant, for example pure oxygen, air or an oxygen-rich gas, into the offgas conduit 39.

Downstream of the offgas filter 31 is disposed a cooling device 32 in particular. The cooling device 32 is, for example, a heat exchanger which is preferably operated in countercurrent with a coolant, such as water. Downstream of the cooling device 32 is preferably a heating device 47 for heating the cooled offgas. The heating device 47 is preferably designed such that it heats the offgas to a temperature of not more than 200° C., in particular 50° C. to 160° C., preferably 70° C. to 120° C. The heating device 47 is preferably designed as a heat exchanger, which is connected to the cooling gas removal conduit 11 such that the cooling gas removed from the shaft 2 is supplied to the heating device 47. The cooling gas filtered in the filter 16 is preferably fed to the heat exchanger 47.

Downstream of the heating device 47 is disposed a branch, via which at least a portion of the offgas is discharged and a second portion is returned to one of the shafts 2 via the offgas conduit 39. In particular, a partial flow of the second portion of the offgas is discharged downstream of the branch of the combustion gas conduit 4. By way of example, the offgas conduit has one compressor 36, 37 each upstream and downstream of the branch of the offgas to be discharged.

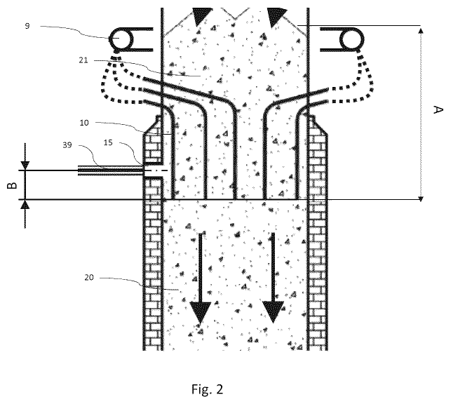

The preheating zone 21 has a second offgas inlet 15 for admission of recirculated offgas, in particular the second portion of the offgas, into the preheating zone 21. The gas inlet 15 is connected via the offgas conduit 39 to the offgas outlet 6 of the shaft 2 such that dedusted and heated offgas discharged from the shaft 2 is conducted into the preheating zone 21. The second offgas inlet 15 is disposed, by way of example, in a lower end region of the preheating zone 21, with the position of the gas inlet 15 shown in detail in FIG. 2. Preferably, the second offgas inlet 15 is disposed downstream of the first offgas inlet 12 in flow direction of the material.

The oxidant conduit 14 preferably has a control element, for example a valve or a flap, by means of which the amount of oxidant entering the combustion gas conduit 4 is adjustable. The control element is preferably connected to the control device, with a control device designed in particular such that it controls the amount of oxidant in the combustion gas conduit 4 depending on the oxygen content and/or CO₂ content of the offgas.

The cooling gas removal conduit 11 preferably has a control element, for example a valve or a flap, which can be used to adjust the amount of cooling gas to be discharged via the cooling gas removal device 17. The control element is preferably connected to the control device, with the control device designed in particular such that it controls the amount of cooling gas discharged via the cooling gas removal device 17 depending on the oxygen and/or CO₂ content of the cooling gas.

The control regime serves in particular to very substantially remove the cooling gas from the PFR shaft kiln 1 while at the same time having a minimum amount of or preferably zero CO₂ in the cooling gas removal conduit 11.

The lime produced with the above-described PFR shaft kiln 1 has high reactivity, with simultaneous production of process gas having a CO₂ content of more than 90% based on dry gas. Such a process offgas can be liquefied and sequestered with a relatively low degree of complexity. For example, the liquefied process offgas is fed to further process steps or stored. Alternatively, the above-described PFR shaft kiln can be used to produce offgas having a low CO₂ content, for example 45% for soda production or 35% for sugar production or 30% for the production of precipitated calcium carbonate.

FIG. 2 shows a detail of a section of the PFR kiln 1 showing the second offgas inlet 15 for admission of offgas into the preheating zone 21. The second offgas inlet 15 has a vertical distance B from the upper end of the burning zone 20, with the upper end of the burning zone 20 disposed at the level of the combustion gas outlet of the burner lances 10. By way of example, the shaft 2 has five burner lances 10, which all end at the same height level. It is likewise conceivable that the burner lances 10 end at different height levels, in which case the upper end of the burning zone 20 begins at the uppermost fuel gas outlet of a burner lance 10. The preheating zone 21 has a length A that extends from the upper end of the preheating zone 21 down to the upper end of the burning zone 20. The upper end of the preheating zone 21 is disposed by way of example at the material inlet 3 or the material bed height. Preferably, the B/A ratio of the distance B to the length A is 0 to 0.5, in particular 0.2 to 3, preferably 0.25. A second offgas inlet positioned at this length ratio gives an optimal introduction position for the offgas.

Preferably, the temperature of the gas within the preheating zone 21 is about 80° C. to 800° C., while the gas at the offgas outlet 6 of the preheating zone 21 is at a temperature of about 80° C. to 100° C., and at the end of the preheating zone 21, in particular the transition between the preheating zone 21 and the burning zone 20, is at about 800° C. to 900° C. The temperature within the preheating zone 21 preferably rises continuously in flow direction of the material. In particular, the second offgas inlet 15 is disposed at a level within the preheating zone 21 at which a temperature of about 500° C. to 700° C., preferably 550° C. to 650° C., in particular 600° C., is established within the preheating zone.

The offgas conduit 39 preferably has a compressor designed to compress the offgas to about 100 mbar to 500 mbar upstream of the inlet into the preheating zone 21.

List of reference signs

| | |
|---|---|
| 1 | kiln |
| 2 | shaft |
| 3 | material inlet/lock |
| 4 | combustion gas conduit |
| 6 | offgas outlet |
| 8 | heating device |
| 9 | fuel conduit |
| 10 | burner lances |
| 11 | cooling gas removal conduit |
| 12 | combustion gas inlet/first offgas inlet |
| 13 | combustion chamber levels |
| 14 | oxidant conduit |
| 15 | gas inlet/second offgas inlet |
| 16 | filter |
| 17 | cooling gas removal device |
| 18 | annular duct/material-free space |
| 19 | connecting duct |
| 20 | burning zone |
| 21 | preheating zone |
| 22 | cooling zone |
| 23 | cooling gas inlet |
| 25 | outlet funnel |
| 26 | inner cylinder |
| 29 | cooling gas outlet |
| 30 | cooling gas inlet |
| 31 | offgas filter |
| 32 | cooling device |
| 33-37 | compressor |
| 39 | offgas conduit |
| 40 | material outlet/lock |
| 41 | discharge device |
| 43 | heat exchanger/recuperator |
| 47 | heating device |
| 48 | cooling air conduit |

1-16. (canceled)

17. A method of burning material, such as carbonate rock, in a parallel-flow regenerative shaft kiln having two shafts which are operated alternately as burning shaft and as regenerative shaft and are connected to one another by a connecting duct, wherein the material flows to a material outlet through a material inlet into a preheating zone for preheating the material, a burning zone for burning the material and a cooling zone for cooling the material, the method comprising:
admitting a cooling gas into the cooling zone; and
discharging offgas from one shaft of the kiln via an offgas outlet disposed within or above the preheating zone;
wherein the offgas discharged from the shaft via the offgas outlet is branched into a first portion of the offgas and a second portion of the offgas;
wherein the first portion of the offgas is fed via a first offgas inlet to an upper region of the preheating zone;
wherein the second portion of the offgas discharged from the shaft is fed to the preheating zone downstream of the first offgas inlet via a second offgas inlet.

18. The method as claimed in claim 17, wherein the oxygen is fed into the first and/or the second portion of the offgas prior to introduction into the preheating zone.

19. The method as claimed in claim 17, wherein the second portion of the offgas, prior to introduction into the preheating zone of the burning shaft, is compressed to about 100 mbar to 600 mbar.

20. The method as claimed in claim 17, wherein the second portion of the offgas is introduced into the preheating zone at the lower end thereof.

21. The method as claimed in claim 17, wherein the second portion of the offgas is heated to a temperature of 500° C. to 800° C. prior to introduction into the second offgas inlet.

22. The method as claimed in claim 17, wherein the second portion of the offgas is introduced into a region of the preheating zone which is at a temperature corresponding to the temperature of the second portion of the offgas and/or a temperature of 500° C. to 800° C.

23. The method as claimed in claim 17, wherein the preheating zone has a length extending in flow direction of the material and wherein the second offgas inlet for admission of offgas into the preheating zone is at a distance from the upper end of the burning zone in flow direction of the material and wherein the ratio of the distance to the length is 0 to 0.5.

24. The method as claimed in claim 17, wherein the cooling gas heated in the cooling zone is discharged from the cooling zone of the shaft via a cooling gas removal device, and wherein the cooling gas discharged from the cooling zone is fed to a heat exchanger for heating the second portion of the offgas.

25. A parallel-flow regenerative shaft kiln for burning and cooling material, such as carbonate rock, comprising:
two shafts that are operable alternately as burning shaft and as regenerative shaft and are connected to one another by a connecting duct;
wherein each shaft has, in flow direction of the material, a preheating zone for preheating the material, a burning zone for burning the material and a cooling zone for cooling the material;
wherein at least one shaft of the PFR shaft kiln has an offgas outlet disposed within or above the preheating zone for discharging offgas from the shaft and a first offgas inlet for admission of offgas;
wherein the offgas outlet is connected to the first offgas inlet for admission of a first portion of the offgas into the preheating zone;
wherein the shaft has, within the preheating zone, a second offgas inlet which is beyond the first offgas inlet in flow direction of the material and which is connected to the offgas outlet for admission of a second portion of the offgas into the preheating zone.

26. The PFR shaft kiln as claimed in claim 25, wherein the shaft kiln has a control element upstream of the first and/or the second offgas inlet for controlling the amount of offgas which is fed via the first and/or second offgas inlet to the preheating zone of the shaft operated as burning shaft and/or of the shaft operated as regenerative shaft.

27. The PFR shaft kiln as claimed in claim 25, wherein the shaft kiln has at least one oxidant conduit which is connected to the first and/or the second offgas inlet for introduction of an oxidant into the offgas.

28. The PFR shaft kiln as claimed in claim 25, wherein a compressor connected upstream of the second offgas inlet is designed and set up such that it compresses the offgas, prior to introduction into the second offgas inlet of the burning shaft, to a pressure of 100 mbar to 600 mbar.

29. The PFR shaft kiln as claimed in claim 25, wherein the second offgas inlet is disposed at the lower end of the preheating zone.

30. The PFR shaft kiln as claimed in claim 25, wherein a heat exchanger disposed between the offgas outlet and the second offgas inlet is designed and set up so as to heat the second portion of the offgas to a temperature of 500° C. to 800° C.

31. The kiln as claimed in claim 30, wherein the cooling zone has a cooling gas inlet for admission of cooling gas into the cooling zone and a cooling gas removal device for discharge of cooling gas from the shaft, and wherein the cooling gas removal device is connected to the heat exchanger for heating of the second portion of the offgas.

32. The PFR shaft kiln as claimed in claim 25, wherein the preheating zone has a length extending in flow direction of the material, and wherein the second offgas inlet for admission of offgas into the preheating zone in flow direction of the material has a distance from the upper end of the burning zone and wherein the ratio of the distance to the length is 0 to 0.5.
